(19) United States
(12) Patent Application Publication
(10) Pub. No.: US 2003/0186589 A1
(43) Pub. Date: Oct. 2, 2003

(54) Electrical connector for interconnection of multiple printed circuit board ground planes

(76) Inventors: Brent A. Holcombe, Bellingham, WA (US); Glenn Wood, Colorado Springs, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/107,912

(22) Filed: Mar. 26, 2002

(51) Int. Cl. H01R 24/00

(52) U.S. Cl. 439/631

(57) ABSTRACT

An electrical connector for electrically interconnecting printed circuit boards. In representative embodiments, an electrical connector is disclosed which comprises a flexible, resilient conductor shaped so as to form first and second end sections located at opposite ends of a central section. The first end section comprises a first segment adjacent to and bent at a first angle from the central section, a second segment adjacent to and bent at a second angle from the first segment, a third segment adjacent to and bent at a third angle from the second segment, and a fourth segment adjacent to and bent at a fourth angle from the third segment. The second end section comprises a fifth segment adjacent to and bent at a fifth angle from the central section, a sixth segment adjacent to and bent at a sixth angle from the fifth segment, a seventh segment adjacent to and bent at a seventh angle from the sixth segment, and an eighth segment adjacent to and bent at an eighth angle from the seventh segment.

### FIELD OF THE INVENTION

The present invention relates generally to radio frequency interference (RFI) suppression and, more particularly, to the suppression of RFI from printed circuit boards.

### BACKGROUND OF THE INVENTION

The emission of radio frequency energy from electronic devices, as for example microwave ovens, computer monitors, computer CPU's, electronic instruments, etc., can interfere with other electronic devices which are operating nearby. Interference of this type, referred to as radio frequency interference (RFI), can cause operational malfunctions in the nearby devices. For this reason, federal standards exist which define acceptable limits for the intensity of radio frequency interference. Thus, the suppression of radio frequency interference from electronic devices is an important design consideration.

Radio frequency interference noise can be suppressed by placing the circuit in a metal chassis. However, for the circuit to be useful, one or more openings must be made in the chassis to provide paths for connecting the circuit to other devices outside the chassis. Such openings, as for example for cable egress, can also provide paths for coupling radio frequency interference from inside the chassis to the world outside it. An instrument chassis which contains multiple independent RFI sources residing on individual printed circuit boards is an especially difficult problem. If these sources are not properly suppressed inside the chassis, RFI noise may be allowed to radiate to areas outside the box, resulting in an instrument which violates federal standards for noise emissions.

Prior solutions involved attempting to connect the signal ground from each of the printed circuit boards to the chassis ground. However, this solution breaks down in the presence of high-frequency emission sources where it is impossible to connect all printed circuit boards though the same short, low-inductance path to chassis ground. In such situations, the high-frequency emission sources will tend to stimulate the metal of each of the printed circuit boards, including their ground planes, differentially which results in those ground planes attempting to return their differential RF energy though any gaps or faults in the chassis including cable openings. In this case, there must be a flexible way to achieve a low-inductive path between the grounds of each of the printed circuit boards. This path should preferably be geographically close to the chassis faults (i.e., cable egress) so as to most efficiently shunt out the RF currents.

### SUMMARY OF THE INVENTION

In representative embodiments, an electrical connector for electrically interconnecting printed circuit boards is disclosed which comprises a flexible, resilient conductor shaped so as to form first and second end sections located at opposite ends of a central section. The first end section comprises a first segment adjacent to and bent at a first angle from the central section, a second segment adjacent to and bent at a second angle from the first segment, a third segment adjacent to and bent at a third angle from the second segment, and a fourth segment adjacent to and bent at a fourth angle from the third segment. The second end section comprises a fifth segment adjacent to and bent at a fifth angle from the central section, a sixth segment adjacent to and bent at a sixth angle from the fifth segment, a seventh segment adjacent to and bent at a seventh angle from the sixth segment, and an eighth segment adjacent to and bent at an eighth angle from the seventh segment.

Other aspects and advantages of the present invention will become apparent from the following detailed description, taken in conjunction with the accompanying drawings, illustrating by way of example the principles of the invention.

### BRIEF DESCRIPTION OF THE DRAWINGS

The accompanying drawings provide visual representations which will be used to more fully describe the invention and can be used by those skilled in the art to better understand it and its inherent advantages. In these drawings, like reference numerals identify corresponding elements.

FIG. 1 is a drawing of multiple printed circuit boards interconnected via an electrical connector as described in various representative embodiments consistent with the teachings of the invention.

FIG. 2 is a drawing of a flexible, resilient conductor as described in various representative embodiments consistent with the teachings of the invention.

FIG. 3A is a drawing of the electrical connector as described in various representative embodiments consistent with the teachings of the invention.

FIG. 3B is a drawing of the electrical connector of FIG. 3A with connected printed circuit boards as described in various representative embodiments consistent with the teachings of the invention.

FIG. 4A is a drawing of another electrical connector as described in various representative embodiments consistent with the teachings of the invention.

FIG. 4B is a drawing of the electrical connector of FIG. 4A with connected printed circuit boards as described in various representative embodiments consistent with the teachings of the invention.

FIG. 5A is a drawing of yet another electrical connector as described in various representative embodiments consistent with the teachings of the invention.

FIG. 5B is a drawing of the electrical connector of FIG. 5A with connected printed circuit boards as described in various representative embodiments consistent with the teachings of the invention.

FIG. 6A is a drawing of the first clasp of the electrical connector as described in various representative embodiments consistent with the teachings of the invention.

FIG. 6B is a drawing of the second clasp of the electrical connector as described in various representative embodiments consistent with the teachings of the invention.

FIG. 6C is a drawing of the additional clasp of the electrical connector as described in various representative embodiments consistent with the teachings of the invention.

### DETAILED DESCRIPTION OF THE PREFERRED EMBODIMENTS

As shown in the drawings for purposes of illustration, the present patent document relates to a novel technique for reducing radio frequency interference (RFI) from electronic devices. Prior solutions involved attempting to connect the signal ground from each of the printed circuit boards to the chassis ground.

In the following detailed description and in the several figures of the drawings, like elements are identified with like reference numerals.

In representative embodiments, an electronic connector is described which is preferably a nickel plated beryllium copper interconnect spring that is designed to connect the ground planes of separate and independent printed circuit boards in a single instrument chasses. It provides a robust conductive connection of the ground planes of multiple printed circuit boards in an instrument or other electronic device. Its connection can be anywhere along the front, back or sides of the printed circuit boards so long as a conductive pattern intended for ground potential is available along the edge of the printed circuit boards. This provides flexibility for the instrument designer to be able to attach the springs in locations, which are convenient, yet geographically near a potential noise carrier. The springs are easily attached and detached, as well as moved around to any desired location on the boards. Power, as well as other potentials, on multiple printed circuit boards can also be connected using the electronic connectors disclosed herein with the appropriate design of the circuit boards.

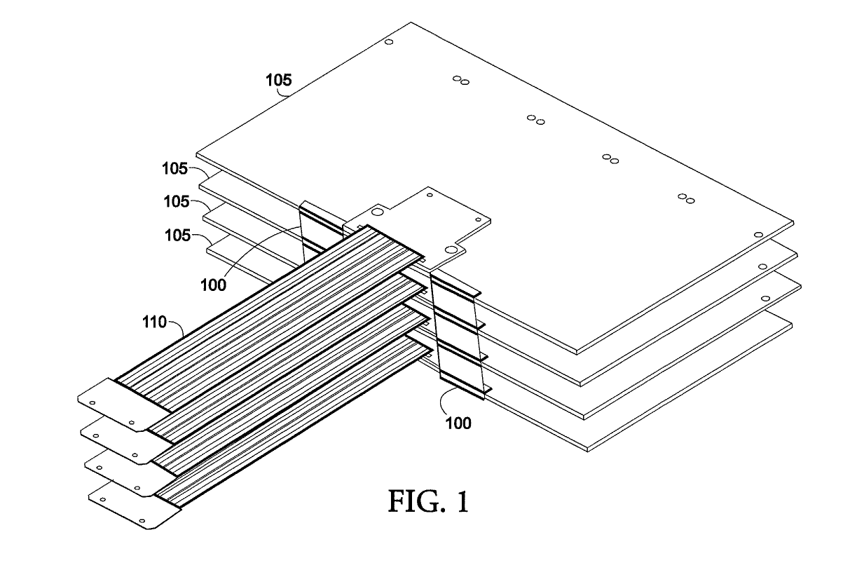

FIG. 1 is a drawing of multiple printed circuit boards 105 interconnected via an electrical connector 100 as described in various representative embodiments consistent with the teachings of the invention. In FIG. 1, various cables 110 interconnect to the printed circuit boards 105. Not shown in FIG. 1 is the chassis in which the printed circuit boards 105 are mounted and the opening(s) through which the cables 110 pass.

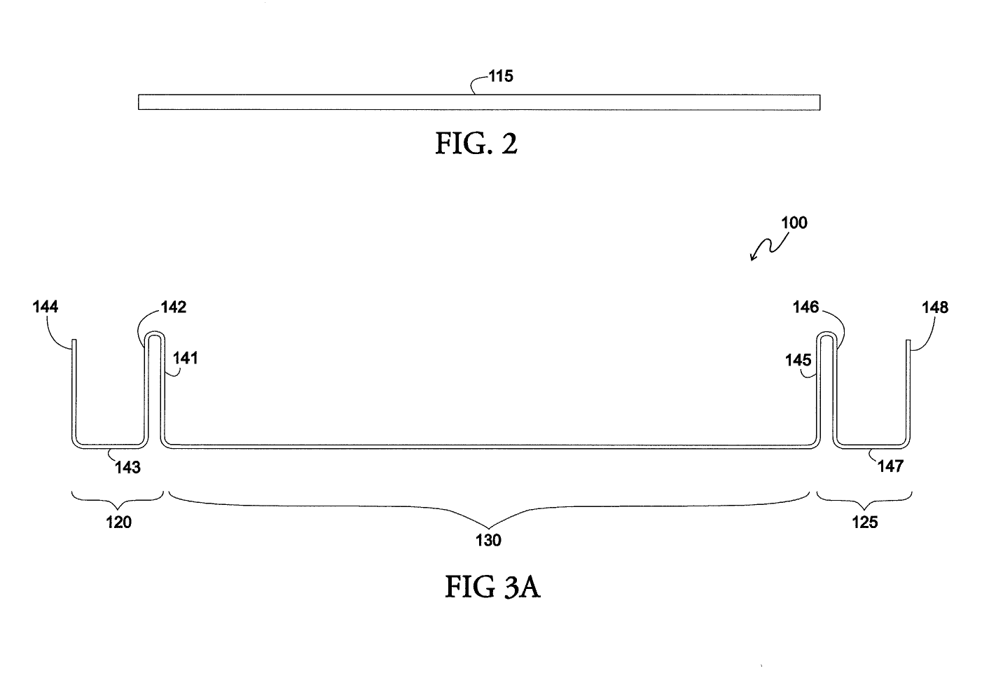

FIG. 2 is a drawing of a flexible, resilient conductor 115 as described in various representative embodiments consistent with the teachings of the invention. In typical applications, the conductor 115 is a sheet of nickle plated beryllium copper.

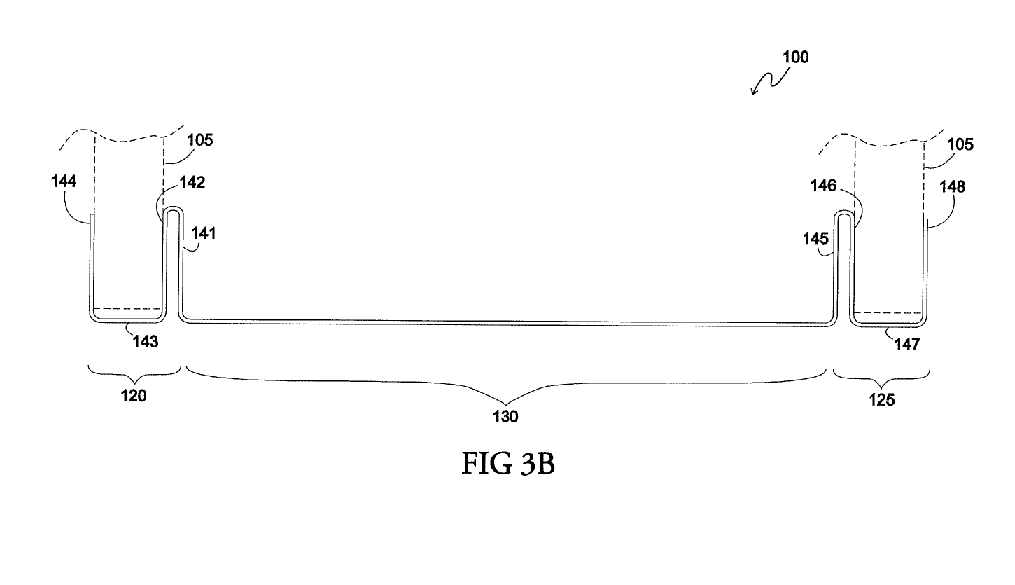

FIG. 3A is a drawing of the electrical connector 100 as described in various representative embodiments consistent with the teachings of the invention. In FIG. 3A, the electrical connector 100 is shaped from the conductor 115 of FIG. 2 so as to form a first end section 120, also referred to herein as a first clasp 120, and a second end section 125, also referred to herein as a second clasp 125, located at opposite ends of a central section 130. The first end section 120 comprises a first segment 141, a second segment 142, a third segment 143, and a fourth segment 144 wherein the conductor 115 is formed so as to create the first, second, third, and fourth segments 141,142,143,144. The second end section 125 comprises a fifth segment 145, a sixth segment 146, a seventh segment 147, and an eight segment 148 wherein the conductor 115 is formed so as to create the fifth, sixth, seventh, and eighth segments 145,146,147,148.

FIG. 3B is a drawing of the electrical connector 100 of FIG. 3A with connected printed circuit boards 105 as described in various representative embodiments consistent with the teachings of the invention. The first clasp 120 formed by first, second, third, and fourth segments 141,142,143,144 grasps the printed circuit board 105 as shown, and the second clasp 125 formed by fifth, sixth, seventh, and eight segments 145,146,147,148 grasps another printed circuit board 105 also as shown. In order to securely grasp the printed circuit boards 105, third and seventh segments 143,147 can be made smaller than the thickness of the printed circuit boards 105, and/or the included angles between second and third segments 142,143, between third and fourth segments 143,144, between sixth and seventh segments 146,147, and/or between seventh and eighth segments 147,148 can be made such that the openings between second and fourth segments 142,144 and between sixth and eight segments 146,148 are smaller than the thickness of the printed circuit boards 105.

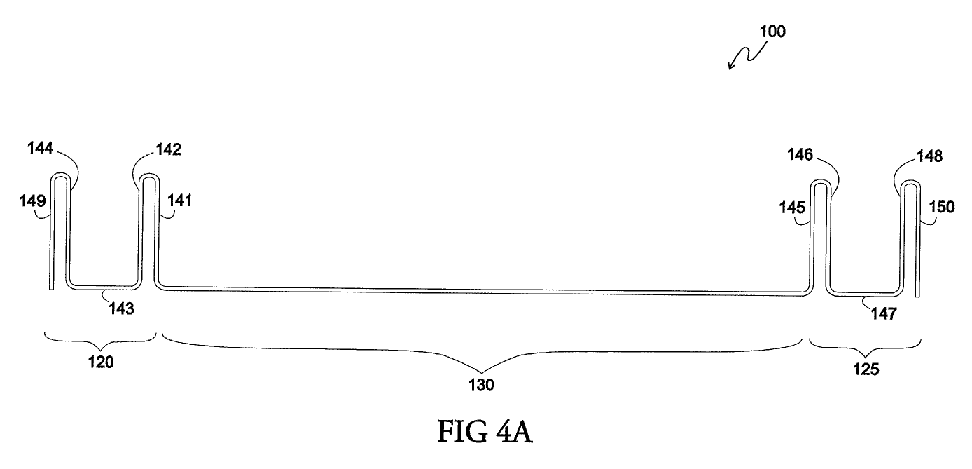

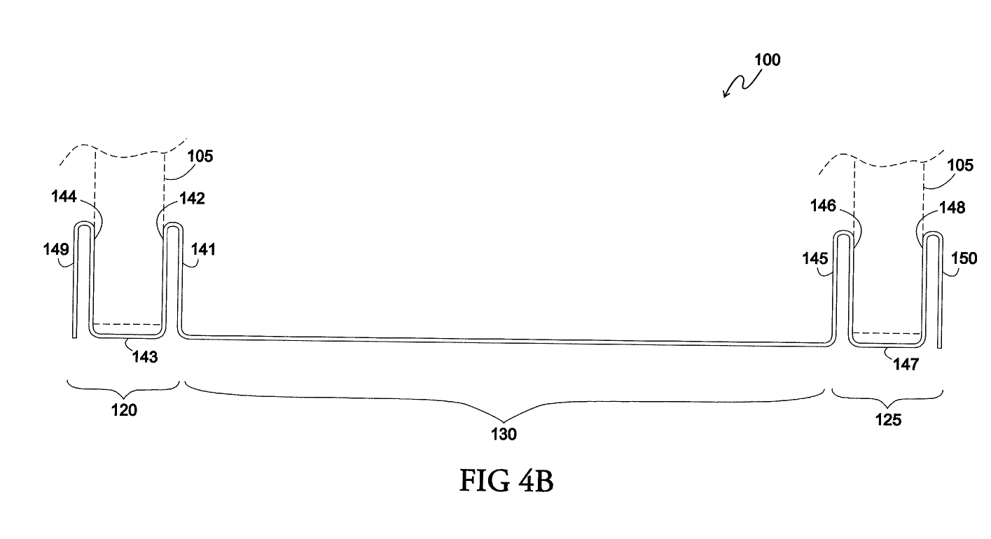

FIG. 4A is a drawing of another electrical connector 100 as described in various representative embodiments consistent with the teachings of the invention. FIG. 4A differs from FIG. 3A in that the first clasp 120 further comprises a ninth segment 149 attached to the fourth segment 144 and in that the second clasp 125 further comprises a tenth segment 150 attached to the eight segment 148. Ninth and tenth segments 149,150 add strength respectively to the first and second clasps 120,125.

FIG. 4B is a drawing of the electrical connector 100 of FIG. 4A with connected printed circuit boards 105 as described in various representative embodiments consistent with the teachings of the invention. FIG. 4B comprises the elements of FIG. 4A with the addition of the printed circuit boards 105 inserted into first and second clasps 120,125.

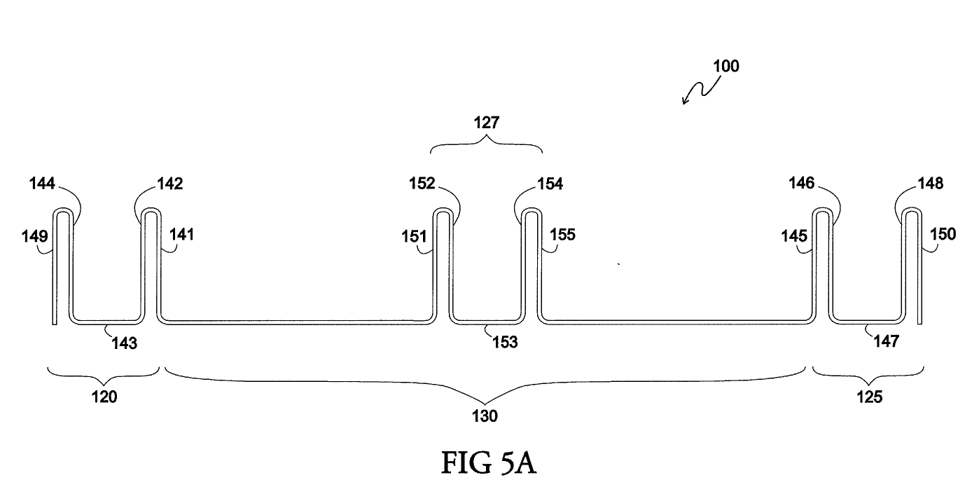

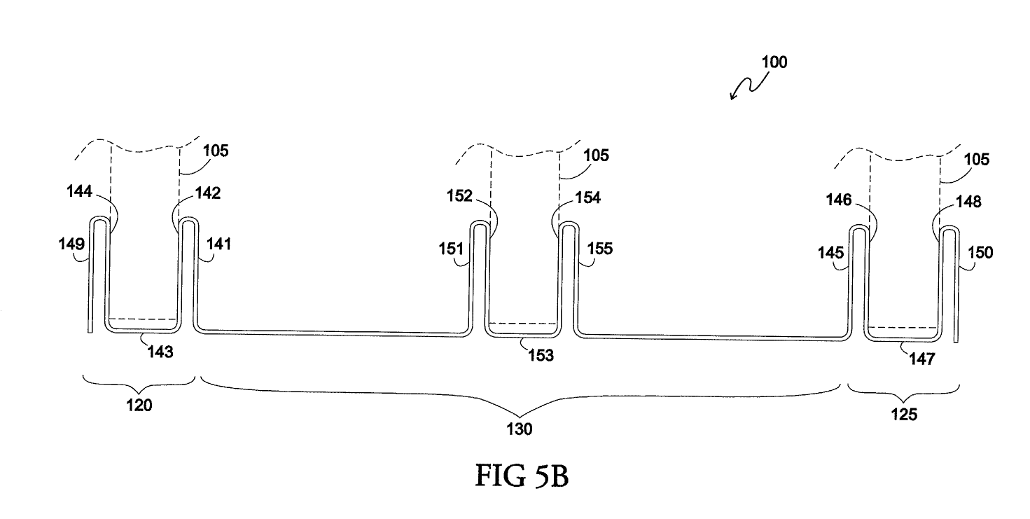

FIG. 5A is a drawing of yet another electrical connector 100 as described in various representative embodiments consistent with the teachings of the invention. In FIG. 4A, an additional section 127, also referred to herein as an additional clasp 127, has been added to the central section 130. The additional clasp 127 comprises eleventh, twelfth, thirteenth, fourteenth, and fifteenth segments 151,152,153,154,155 wherein the conductor 115 is formed so as to create the eleventh, twelfth, thirteenth, fourteenth, and fifteenth segments 151,152,153,154,155.

FIG. 5B is a drawing of the electrical connector 100 of FIG. 5A with connected printed circuitboards 105 as described in various representative embodiments consistent with the teachings of the invention. FIG. 5B comprises the elements of FIG. 5A with the addition of three printed circuit boards 105 inserted into the first, second and additional clasps 120,125,127.

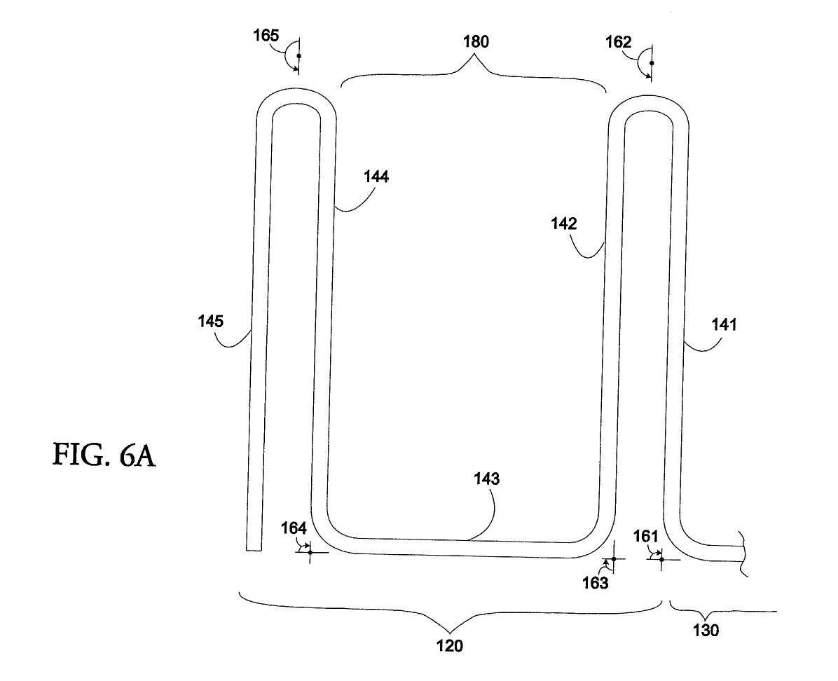

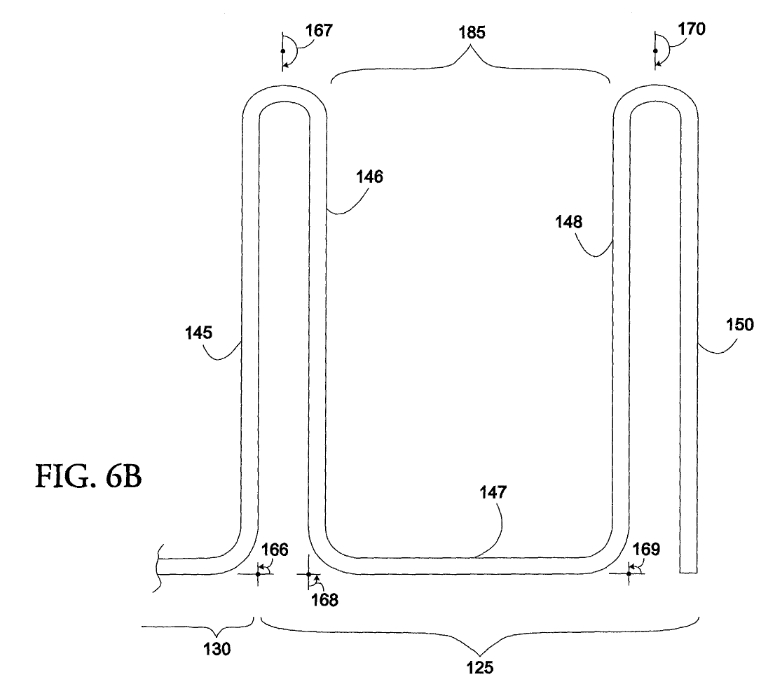

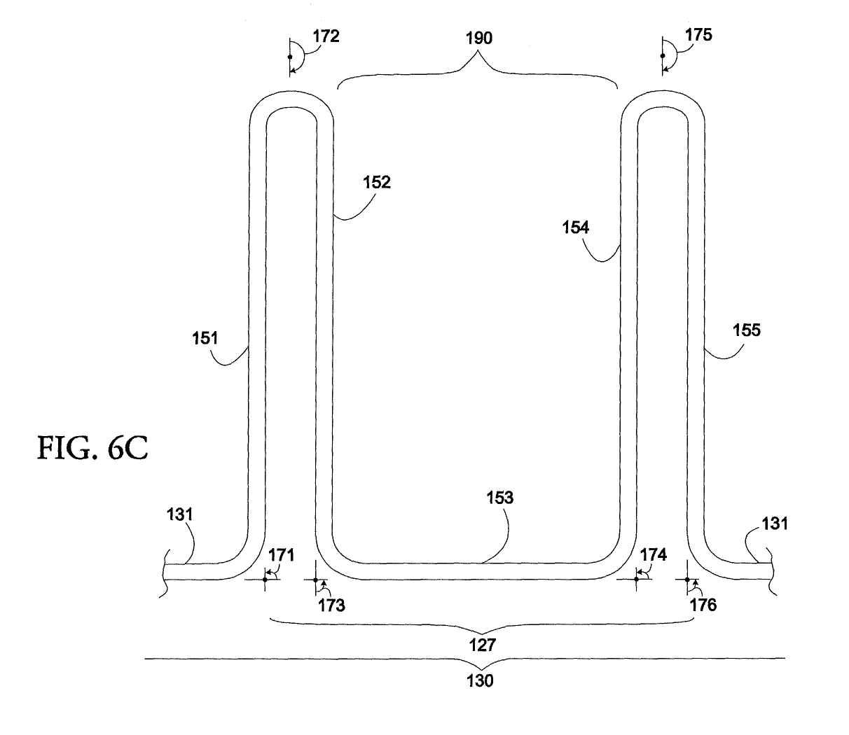

FIG. 6A is a drawing of the first clasp 120 of the electrical connector 100 as described in various representative embodiments consistent with the teachings of the invention. In the representative embodiment of FIG. 6A, the first clasp 120 comprises the first segment 121 adjacent to and bent at a first angle 161 from the central section 130, the second segment 142 adjacent to and bent at a second angle 162 from the first segment 141, the third segment 143 adjacent to and bent at a third angle 163 from the second segment 142, the fourth segment 144 adjacent to and bent at a fourth angle 164 from the third segment 143, and the ninth segment 149 adjacent to and bent at a fifth angle 165 from the fourth segment 144. In a representative embodiment, the first angle 161 is substantially ninety degrees, the second angle 162 is substantially one hundred eighty degrees, the third angle 163 is substantially ninety degrees, the fourth angle 164 is substantially ninety degrees, and the fifth angle 165 is substantially one hundred eighty degrees. A slight deviation from these angles, as for example making the third angle 163 and/or the fourth angle 164 slightly greater than ninety degrees provides a first opening 180 capable of more firmly grasping the printed circuit board 105.

FIG. 6B is a drawing of the second clasp 125 of the electrical connector 100 as described in various representative embodiments consistent with the teachings of the invention. The second clasp 125 comprises the fifth segment 145 adjacent to and bent at a sixth angle 166 from the central section 130, the sixth segment 146 adjacent to and bent at a seventh angle 167 from the fifth segment 145, the seventh segment 147 adjacent to and bent at an eighth angle 168 from the sixth segment 146, the eight segment 148 adjacent to and bent at a ninth angle 169 from the seventh segment 147, and the tenth segment 150 adjacent to and bent at a tenth angle 170 from the eight segment 148. In a representative embodiment, the sixth angle 166 is substantially ninety degrees, the seventh angle 167 is substantially one hundred eighty degrees, the eighth angle 168 is substantially ninety degrees, the ninth angle 169 is substantially ninety degrees, and the tenth angle 170 is substantially one hundred eighty degrees. A slight deviation from these angles, as for example making the eighth angle 168 and/or the ninth angle 169 slightly greater than ninety degrees provides a second opening 185 capable of more firmly grasping the printed circuit board 105.

FIG. 6C is a drawing of the additional clasp 127 of the electrical connector 100 as described in various representative embodiments consistent with the teachings of the invention.

In FIG. 6C, the central section 130 comprises at least one additional clasp 127, wherein the additional clasp 127 comprises the eleventh segment 151 adjacent to and bent at an eleventh angle 171 from a base area 131 of the central section 130, the twelfth segment 152 adjacent to and bent at a twelfth angle 172 from the eleventh segment 151, the thirteenth segment 153 adjacent to and bent at a thirteenth angle 173 from the twelfth segment 152, the fourteenth segment 154 adjacent to and bent at a fourteenth angle 174 from the thirteenth segment 153, and the fifteenth segment 155 adjacent to and bent at a fifteenth angle 175 from the fourteenth segment 154. The fifteenth segment 155 is also bent at a sixth angle 176 with respect to the base area 131 of the central section 130. In a representative embodiment, the eleventh angle 171 is substantially ninety degrees, the twelfth angle 172 is substantially one hundred eighty degrees, the thirteenth angle 173 is substantially ninety degrees, the fourteenth angle 174 is substantially ninety degrees, the fifteenth angle 175 is substantially one hundred eighty degrees, and the sixteenth angle 176 is substantially ninety eighty degrees. A slight deviation from these angles, as for example making the thirteenth angle 173 and/or the fourteenth angle 174 slightly greater than ninety degrees provides a third opening 190 capable of more firmly grasping the printed circuit board 105.

In a representative embodiment, the electrical connector 100 is constructed by cutting a piece of sheet stock Beryllium Copper of an appropriate thickness, bending the sheet over an appropriately sized die and anvil tool, and bending the sheet to create spring loaded features that are slightly undersized from the thickness of the printed circuit boards that the spring is being attached to. Once the spring is formed, it is nickle plated and slid into place over exposed metal on the top or bottom layer which is connected to ground on the printed circuit boards.

A primary advantage that the electrical connector 100 has over prior techniques is that it provides a geographically flexible, low inductance path between the grounds of multiple printed circuit boards 105. This flexibility provides the instrument designer with additional freedom as to where to locate this path so long as exposed conductive geometries are present at or near the edges of the printed circuit boards. An additional advantage is that the solution is evolutionary in nature. The design of the spring can be performed late in the design cycle. The circuit designer can implement a custom solution after the initial design and RF testing are completed. This feature limits the role that the RFI suppression process plays in constraining the overall design of the electronic device. The relative ease of manufacturing a custom solution allows for its implementation late in the product development life cycle.

While the present invention has been described in detail in relation to preferred embodiments thereof, the described embodiments have been presented by way of example and not by way of limitation. It will be understood by those skilled in the art that various changes maybe made in the form and details of the described embodiments resulting in equivalent embodiments that remain within the scope of the appended claims.

What is claimed is:

1. An electrical connector for electrically interconnecting printed circuit boards, comprising:
a flexible, resilient conductor shaped so as to form first and second end sections located at opposite ends of a central section,
wherein the first end section comprises
a first segment adjacent to and bent at a first angle from the central section,
a second segment adjacent to and bent at a second angle from the first segment,
a third segment adjacent to and bent at a third angle from the second segment, and
a fourth segment adjacent to and bent at a fourth angle from the third segment, and
wherein the second end section comprises
a fifth segment adjacent to and bent at a fifth angle from the central section,
a sixth segment adjacent to and bent at a sixth angle from the fifth segment,
a seventh segment adjacent to and bent at a seventh angle from the sixth segment, and
an eighth segment adjacent to and bent at an eighth angle from the seventh segment.

2. The electrical connector as recited in claim 1, wherein the first angle is substantially equal to ninety degrees.

3. The electrical connector as recited in claim 1, wherein the second angle is substantially equal to one hundred eighty degrees.

4. The electrical connector as recited in claim 1, wherein the third angle is substantially equal to ninety degrees.

5. The electrical connector as recited in claim 1, wherein the fourth angle is substantially equal to ninety degrees.

6. The electrical connector as recited in claim 1, wherein the fifth angle is substantially equal to ninety degrees.

7. The electrical connector as recited in claim 1, wherein the sixth angle is substantially equal to one hundred eighty degrees.

8. The electrical connector as recited in claim 1, wherein the seventh angle is substantially equal to ninety degrees.

9. The electrical connector as recited in claim 1, wherein the eighth angle is substantially equal to ninety degrees.

10. The electrical connector as recited in claim 1, wherein the first end section further comprises
a ninth segment adjacent to and bent at a ninth angle from the fourth segment.

11. The electrical connector as recited in claim 10, wherein the ninth angle is substantially equal to one hundred eighty degrees.

12. The electrical connector as recited in claim 10, wherein the second end section further comprises
a tenth segment adjacent to and bent at a tenth angle from the eighth segment.

13. The electrical connector as recited in claim 12, wherein the tenth angle is substantially equal to one hundred eighty degrees.

14. The electrical connector as recited in claim 1, further comprising
wherein the central section comprises at least one additional section
wherein the additional section comprises
an eleventh segment adjacent to and bent at an eleventh angle from the central section,
a twelfth segment adjacent to and bent at a twelfth angle from the eleventh segment,
a thirteenth segment adjacent to and bent at a thirteenth angle from the twelfth segment,
a fourteenth segment adjacent to and bent at a fourteenth angle from the thirteenth segment, and
a fifteenth segment adjacent to and bent at a fifteenth angle from the fourteenth segment.

15. The electrical connector as recited in claim 14, wherein the eleventh angle is substantially equal to ninety degrees.

16. The electrical connector as recited in claim 14, wherein the twelfth angle is substantially equal to one hundred eighty degrees.

17. The electrical connector as recited in claim 14, wherein the thirteenth angle is substantially equal to ninety degrees.

18. The electrical connector as recited in claim 14, wherein the fourteenth angle is substantially equal to one hundred eighty degrees.

19. The electrical connector as recited in claim 14, wherein the fifteenth angle is substantially equal to ninety degrees.

20. The electrical connector as recited in claim 1, wherein the conductor is fabricated from beryllium copper.

21. The electrical connector as recited in claim 20, wherein the beryllium copper conductor is nickle plated.
